(19) United States
(12) Patent Application Publication
(10) Pub. No.: US 2011/0258351 A1
(43) Pub. Date: Oct. 20, 2011

(54) Private restricted access email & storage system & method

(76) Inventor: Steve Kim, Cerritos, CA (US)

(21) Appl. No.: 12/799,270

(22) Filed: Apr. 20, 2010

(51) Int. Cl. G06F 13/12

(52) U.S. Cl. 710/74

(57) ABSTRACT

A private restricted access email & storage system which utilizes a connector for connection to a conventional computer, a flash drive connected to the connector and a micro-controller connected to at least one of the connector and the flash drive and which may, in combination with the permissions and compatibility detected in the conventional computer, enable selected access to the flash drive to perform private email and file access functions.

### BACKGROUND OF THE INVENTION

This invention relates to an improved method and technique for secure and controlled isolation of messages and files which will give the benefits of communicating and saving in an electronic environment, along with the security and controllability similar to but much in excess of conventional paper transfers.

### BACKGROUND OF THE INVENTION

In the current environment of email, hacking and generally free and open access to files and communications, the price of loss of confidentiality is paid in exchange for ease and flexibility of communication, and ease of reproduction. For email, a transmission from one location to the other involves multiple copies being created and shared widely over the world wide web. Multiple copies of computer files are often made by design or inadvertently from normal use, with much of any change history contained within the stored file. However, the difficulty generally inherent with a return to a paper system and its physical constraints, is generally not worth the loss in flexibility. This is so, especially since the security associated with paper alone is low.

Similarly, to provide a very secure computer with high security fire walls, tamper detection systems, and restricted, slowed, or compromised communication ease can be an expensive and technical solution to a desire for enhanced security. Further, nearly every computer is used for a mixture of personal communications, business and entertainment. A high security computer system which is acceptable for business would have its personal communication and entertainment function severely burdened. A good example can be had by asking anyone in government who uses a computer about how restrictive the use of the computer can be. High risk sites are simply blocked off from the user's view where such high risk site might otherwise compromise security. Put simply, each persons computer has such a predominance of personal use that the burdening of the personal computer is unacceptable.

Another factor is the cost of high security. Not only is the cost of maintaining a high security, well protected computer quite high, to achieve the highest security, it cannot have its guard lowered even for brief time periods where the unrestricted use is desired. A user might elect to have two computers, one for highly secure business uses and another for flexible communication and entertainment. To some extent the “second computer” need has been partially satisfied by telephonic devices like the blackberry, but this is still insufficient compared to the need for a relaxed personal computing solution. Short of providing two complete computer systems, one secure and one of relaxed security, no method has yet been devised to fully meet the needs of both types of system.

Even where one computer system is completely impregnable, it can still fall victim to disclosure to others through the discovery procedures related to the legal process. In a parallel to the expansion of practical communications technology, the courts have taken notice of the expansion and have adjusted their discovery powers to enable law enforcement and private plaintiffs and defendants an expansive entry into any computer systems in the control of the user. In some cases, competitors may bring suit in order to discover the most sensitive information of its competitors. The mechanisms to isolate each side in the controversy from the other's secrets often fall short of their intended protective effect.

In effect, high isolation can only be had by forming information and then putting it out of reach. Even where the information can be sent to a position out of reach, a record of the formation the formation and receipt of other information remains upon the user's computer. If the computer is accessed by information technology professionals, and subject to some limitations, all of the information in the computer can be accessed. Isolation of information can be had by destroying the computer's hard drive, as mere writing over a hard drive can be forensically reversed and the information extracted. Thus as can be seen, even feeble attempts to periodically destroy information are expensive and will generally be ineffective.

Achieving a state of selective sharing is also problematic. When computer files are shared, everyone sharing will generally have access to the files being shared, regardless of whether they have an access permission to open the file. The result is that the number of files in a group will be multiplied by the members who have access to those files, and even more where the group members can copy and send the files elsewhere.

What is needed is a system in which the high security system only applies to a limited area of a computer, and where the files cannot be copied off of the limited area (but may, subject to some permissions allow for file backup for certain users and under certain circumstances), and which absent a backup will leave no external record, not even a trace that the secure files were present, nor altered, nor accessed by a computer. What is needed is the ability to divest possession of the limited computer area, to place possession of the limited file area beyond control, and especially to allow the same sorts of physical collection and accountability of areas and files as would be present where a notebook were passed around in a design group, for example. Trade secret type access systems where the discloser makes material available to a disclosee under signature warning and where it is agreed that no copying can occur and where the books have to be returned on demand, represents one sort of system illustrating the benefits of a system in which physical possession can operate to encourage controllable confidentiality. The needed system area should have the ability for encryption according to protocols for communication and files passing into and out of the needed system area. The system area should be portable and contain as much of the programs required for facilitating communication, encryption, text and computational operation and copy restriction as is possible. Where possible, the protected area should utilize its own operational programs, so that the user can use a mouse and keyboard to communicate across the secure area, and so that any automatic back up function which would be present in the program being used would be safely within the protected area. Where external programs are used, which is not nearly desired, they should be subject to checking to insure that no physical backup record is created outside of the protected area, and that no indication of the use of the area remains with the main computer. It is preferable for the protected area to be physically disconnected from the computer and have its custody dependent upon physical transport.

### SUMMARY OF THE INVENTION

The invention uses flash, or thumb drive, technology to produce a physically segregable, encrypted, controlled access system with its own historical data register indicating who accessed the drive, what changes were made to programs and data files on the drive, as well as what messages were sent into the drive for others, what messages were read and when, in addition to a number of other optional and user specified capabilities. In effect a private restricted access email & storage system & method provides a physical housing, preferably having the size and connectivity of a flash drive which can be accessed by any ordinary computer, but whose operability will depend upon programming carried on the flash drive. Depending upon user preference, the program provided by the flash drive will enable its replication into the main computer where desired, and block such operation where desired. Further user election can include the provision of a backup of the files on the flash drive or the blocking of the ability to form backup files.

The number and user specification of controlled use aspects of the private restricted access email & storage system & method are many and include:

A tool that lets a master user control the extent to which other users can create and edit email using familiar tools and tools similar in function to those familiar tools, including Gmail (Google), Yahoo Mail, and Hotmail;

Different security settings and file and email availability for each user which can access the system and method of the invention;

Encryption with encryption keys which may be controlled either internal or external to the system and method of the invention;

Self-destruct capability for the system and method of the invention where unauthorized users go beyond a given threshold of specified steps for obtaining unauthorized access;

Detachability of the drive to involve leaving no indicia on the computer accessing the system and method of the invention of any files or changes to files on the drive, including an isolation of the running of programs to occur physically on the drive, as well as a shutting down and erasure of any programs which were run on the computer's volatile memory;

The optional provision of a complete set of operable programs to be provided within the physical boundary of the drive for the system and method of the invention; and

The ability to use the drive with the system and method of the invention to physically isolate and remove custody of the files, emails send and received, from the computer by unplugging it from the computer from which it was accessed.

The operation of the flash drive of the system and method of the invention may involve, for example, password entry to access the encrypted USB drive, followed by presentation of user choices for access of an email window, a pop up with sender's messages & attachments, a click reply button, a typed response box, a searching function, a history of activity on the USB drive, optional file type and save on a specified user computer drive or restricted to a portion of the drive's memory, a stated warning that there will be no way to retrieve that information if USB flash drive is ever lost, and a usual requirement that the USB flash drive of the system and method of the invention must be delivered by hand or article carrier (such as Fed Ex) back to a further user.

Mail message hierarchy can include levels of security including private communication between just the sender and the receiver, secure multi recipient access with encryption and password protection, or general messages for all users of the device, which, even at a general level is more secure than general email because there is no footprint left in cyberspace since its not transferred across an electronic network or through a computer electronically. Communication is had through files in flash memory and which may be further restricted by limited access. An optional history function can have informational level set to provide the when, where, who, why and how details of each time it is used and by which restricted users. Because the system and method of the invention uses flash technology, large video, audio, pdf and jpeg files can be stored and accessed. The system and method of the invention supports green initiatives that rely less on paper and more on Flash memory, and the use of a physically segregable device helps organize all files and communication physically, and within each device chronologically, with appropriate minute records of which user had access to what files, as well as who looked at which filed, and helps both keep projects segregated and confidential by the use of an electronic record which may be copy prohibited and which may have a better chance of insuring confidentiality and secrecy based upon the ability to control possession of a conventional the flash drive.

Because the files are physically segregated, the system and method of the invention will save time required to search for files, help easily identify what is to be done with each file, and will not be confused with other conventional USB flash drives.

Further, a small portable volatile-only memory microcomputer may be utilized with the system and method of the invention to even further and physically insure that some users may not have any capability to make backup files nor leave any footprint, especially where other computers may have more than usual capabilities which are dangerous to confidentiality, including a keystroke recorder, for example.

The need for the system and method of the invention is clear, and individuals and industry segments which need the system and method of the invention include:

executives who need to communicate sensitive information that nobody can ever retrieve through a third party in future;

government which needs to have control of sensitive information without ever risking leaving a footprint in cyberspace and who may need to keep a secured detail record of all files, receipt or information shared to who, when, where and how;

private citizens who believe that the ability to send their information, images, videos or messages in privacy is of the utmost importance;

engineers who need to communicate and share large files with other engineers and track the progress of a project;

media companies who need to send and receive breaking videos, photos and stories in encrypted files;

ad agencies who send ad layouts, commercials or label designs to clients for approval and want to keep all comments and approvals logged into the file for record;

school students who need to label and identify their class assignments so that they can get their credits and teachers who want to identify and grade each students work without having to make a separate note on paper for each student;

military families who want to send large video or audio files with ability to send, receive and respond without paper in total privacy;

medical professionals to keep a digital file of photos, videos, x-rays, diagrams with all the information that would normally be included in medical files, which would save enormous space and ability to back up not only the accounting but every details of the patient's entire history;

Businessmen who travel abroad and want to keep all contacts and organizer without relying on their computer or the Internet to access their information;

celebrities who cannot afford to take any chances of their personal images or messages sent to their family or partner;

sales people who need electronic forms that they can carry and record all sales calls made, expenses, receipts and the ability to add a written report daily for submission without relying on any one computer;

Diary keepers who want to be explicit and completely honest in their diary but cannot, due to the fear that an unauthorized person could one day access their diary against their wishes; and

all others who will realize that the system and method of the invention will do more and cost the same compared to all other USB's currently in the market place.

### BRIEF DESCRIPTION OF THE DRAWINGS

The invention, its configuration, construction, and operation will be best further described in the following detailed description, taken in conjunction with the accompanying drawings in which:

FIG. 1 is a schematic perspective view of a simple embodiment of a conventional computer connected through a USB connector to a flash drive.

### DETAILED DESCRIPTION OF THE PREFERRED EMBODIMENT

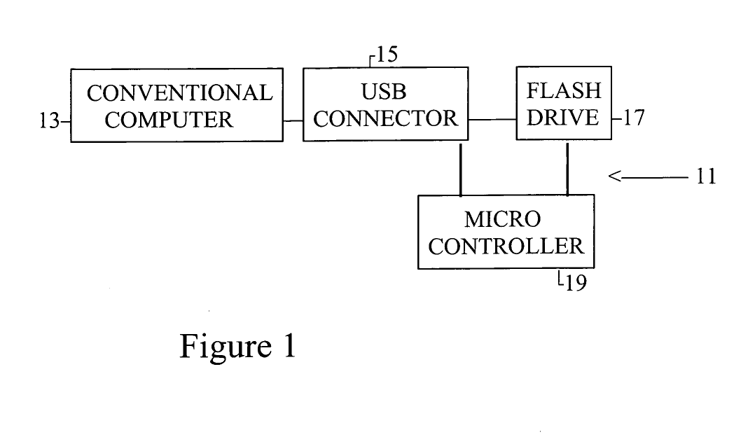

Referring to FIG. 1, a block diagram illustrates a block diagram representation of the system and method of the private restricted access email & storage system & method invention 11. A conventional computer 13 connected through a connector, which may preferably be a USB connector 15, to a flash drive 17. The conventional computer 11 may have a conventional storage drive, screen and keyboard, and Internet connectivity. Further, the conventional computer 13 may be a secure computer in which no storage is possible. The USB connector 15 may actually be a connector of any type, but the USB format is believed to be compatible with the system and method of the invention and it may be more helpful to explain the invention utilizing a popular interconnect format such as USB. The flash drive 17 represents a non-volatile and controllable memory. Also shown is a micro-controller 19 which may include connectibility to the USB connector 15, flash drive 17, or both. Micro-controller 19 can control the flash drive 17 and possibly control the access of the USB connector 15 to the flash drive 17 or require a number of permissions to give access to the flash drive 17. The control software can give the control user a plethora of options, including a distributed selective access.

While the present invention has been described in terms of a private restricted access email & storage system & method, one skilled in the art will realize that the structure and techniques of the present invention can be applied to many devices including any device which utilizes the embodiments of the isolation and footprint conservation techniques described and equivalents thereof.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed is:

1. A private restricted access email & storage system comprising:
a connector;
a flash drive connected to the connector; and
a micro-controller connected to at least one of the connector and the flash drive, to control access to the flash drive when the connector is connected to a conventional computer.
